(19) United States
(12) Patent Application Publication
(10) Pub. No.: US 2008/0040269 A1
(43) Pub. Date: Feb. 14, 2008

(54) Method and apparatus using an indirect address code for delivery of physical article

(76) Inventors: William Deans, San Mateo, CA (US); Prasanna Mulgaonkar, San Mateo, CA (US); Gregory Myers, San Mateo, CA (US); John P. Marcotullio, San Mateo, CA (US)

Correspondence Address: DICKSTEIN SHAPIRO LLP, 1825 EYE STREET NW, Washington, DC, 20006-5403, US

(21) Appl. No.: 11/890,529

(22) Filed: Aug. 7, 2007

Related U.S. Application Data
(63) Continuation of application No. 10/275,559, filed on Mar. 26, 2003, now abandoned.

(51) Int. Cl. G06Q 10/00; G06Q 30/00

(52) U.S. Cl. 705/40; 705/1; 705/39

(57) ABSTRACT

The present invention provides methods and apparatus for delivering a physical item such that an indirect address code (IAC) (102) is added to a physical item (112), subsequently evaluated into a deliverable address (118), and associated to the item to enable in delivery of the item. An efficient and secure method of delivery of a physical item is thereby achieved.

This application claims the benefit of U.S. provisional application No. 60/202566, incorporated herein by reference in its entirety.

### FIELD OF THE INVENTION

The field of the invention is delivery systems for physical items.

### BACKGROUND OF THE INVENTION

Most modern systems of delivery rely upon the addition of a deliverable address to a physical item; The item is then physically delivered to the recipient using the deliverable address. That process is often aided by the inclusion of a postal code, such as a ZIP Code or its equivalent outside of the United States. The postal code assists in the routing of the item through one or more transfer and sorting stations, such as a Post Office, and delivered to a location corresponding to the deliverable address.

One problem with such delivery systems is that a large number of people frequently change the location of their home or business or maintain multiple addresses. The U.S. Census Bureau statistics on mobility indicate that annually, over 15% of the population change their domicile, and over thirty percent of Americans between the ages of 20 and 35 move every year. Indeed, over forty million change-of-address forms are processed by the United States Postal Service (USPS) each year. The USPS uses the change-of-address form to provide temporary forwarding services for certain classes of mail. Nevertheless, the addressee must eventually provide the new address to all of their contacts including friends, family, services providers, and business contacts. Each time an entity moves, there is an increased probability that items addressed to the entity will contain the old address. If the entity files a change of address form, there is a chance of error in the processing of the form that may result in additional items becoming obsolete or undeliverable as addressed (UAA). In addition, the processing of the change of address forms may be delayed resulting in attempted delivery of items to an obsolete address. Thus, there is a need for a system that would assist the Post Office in resolving undeliverable and obsolete addresses, for example, by decreasing the number of change of address forms being submitted to the USPS.

Traditionally, the USPS does not discover that an item must be forwarded (as a result of a change-of-address) until the item reaches the letter carrier. At that point the responsibility rests with the carrier to identify the item as requiring forwarding, and to subsequently send the item on to the new address (perhaps via a Mail Forwarding Center). Systems such as that proposed by U.S. Pat. No. 5,703,783 to ElectroCom Automation, L.P. (June 1995), the disclosure of which is incorporated by reference in its entirety, attempt to automatically route obsolete mail to the correct destination. However, that solution depends on the ability of a sorter to determine the correct address from the address on the mail piece by comparing it to entries in the National Change of Address (NCOA) database. The NCOA database attempts to provide data to enable evaluation of a former deliverable address into a current deliverable address. The address on the mail piece may not be susceptible to evaluation into the recipient's current deliverable address by that system. The address may be illegible or it may not have a corresponding entry in the NCOA database (entries in the NCOA expire after a certain amount of time.) A more efficient system might decrease the quantity of items requiring NCOA evaluation while at the same time reducing the cost, inconvenience and potential for error.

Another way of dealing with a highly mobile society is through the use of Post Office Boxes (P.O. Boxes), because the P.O. Box allows a recipient to move locally and still maintain the same mailing address. However, a problem with P.O. Boxes is that it is often necessary for the recipient to travel to the location of the box. Therefore, if the person has moved out of the local area, it may be inconvenient for them to retrieve mail from the box.

Even where the deliverable address is known, the use of the deliverable address may be undesirable for a variety of reasons, many of which amount to a loss of privacy. Whenever a deliverable address is revealed, there is a possibility that the address will find its way onto someone's mailing list, resulting in undesired mail solicitations (also called “direct mail” or “junk mail”). In the realm of mail order and Internet commerce, a deliverable address can often be used as a unique identifier for a customer, enabling the correlation of customer purchases with customer identity. The result of such a correlation is a “profile” of the customer's interests and buying habits, and while such a profile may allow the business to tailor its services to the customer, it may also expose the customer to unwanted solicitations. The risk is not imaginary. Some vendors count their customer database among their tangible assets making the database vulnerable to sale, exchange, or acquisition. Often vendors share their customer information as a matter of course. The risk of additional mail solicitations and profiling, not to mention fraud or outright identity theft, may compel an entity (person or business) to forego the use of mail order and the Internet altogether. A better system would allow an entity to participate in mail order and online transactions, while shielding the entity's deliverable address.

One method that contemplates the use of an undeliverable address is the method proposed by iprivacy.com. iprivacy's method contemplates an online purchaser downloading software that encrypts the purchaser's identity and address into a “private” identity and address. The “private” data is communicated to the online vendor who does not become aware of the “true” identity and address of the purchaser. Decryption software is required by the entity that decrypts the “private” address into a “true” address. iprivacy's method is inadequate, however, because a method that relies on software to enable decryption of a “private” address is subject to security breaches by anyone who can obtain the software and thus the decryption algorithm. A better system may make use of a secure database to cross reference an undeliverable address with a deliverable address.

Thus, current systems' of delivery are flawed, particularly because of the quantity of undeliverable mail generated, and the failure to minimize the publication and distribution of one's name and deliverable address.

### SUMMARY OF THE INVENTION

The present invention provides systems and methods for delivering a physical item by associating an Indirect Address Code (IAC) to the item, placing the physical item into the stream of delivery, using a reference file to derive a deliverable address from the IAC, associating the deliverable address to the item, and then physically delivering the item by transporting it to the deliverable address.

In a preferred embodiment, the IAC may be obtained from the item via optical character recognition (an automation process which is already in use at the USPS and other delivers), and evaluation of the IAC into the deliverable address is done automatically by accessing the file using the IAC as a key. Thus, there is indirectness in the evaluation of the IAC into the deliverable address because the IAC is not a deliverable address, but describes where to find the deliverable address.

Different IACs may evaluate to the same delivery address. This would be desirable, for instance, if several entities reside at the same deliverable address. Any or all of the information in an IAC database record can be mutable. For example, when the entity associated with an IAC moves, the former deliverable address can be replaced with the new deliverable address. In addition, the IAC itself (and the associated record) may be deleted from the database. This may happen exclusive of the request of the recipient or at the request of the recipient, and may have the effect of destroying the mapping from the IAC to a deliverable address. In some variations, an IAC might allow for only a single use (i.e. a single query by the deliverer for the deliverable address) and expire thereafter.

The process of adding the deliverable address to the physical item has many variations. It is contemplated that the deliverable address may be added to the physical item by affixing a label. In alternative embodiments, the deliverable address is added by printing or spraying on the physical item or by affixing a barcode label. In a particular embodiment, the deliverable address may obscure the IAC. By performing this process in a secure environment, the anonymity of the addressee can be preserved to all but the deliverer who physically transfers the item to the deliverable address.

In another aspect the AC can comprise a ‘smart code’ that may have at least one internal mechanism for ensuring its integrity or otherwise assessing its validity. It is contemplated that the IAC may have a checksum digit that will be used to validate the IAC, and possibly correct errors in its interpretation. Other contemplated versions enable integrity checks of the IAC through at least one of a cyclic redundancy check, a parity check, and an error correction code.

Another way of viewing the inventive subject matter is a method of conducting business that involves assigning an IAC to an entity, accepting an order, associating the order with a deliverable shipping address, and shipping the item to the deliverable shipping address. It is contemplated that assignment of the IAC will occur under the authority of a single secure provider. The secure provider may be a new company or an existing entity, such as the United States Postal Service (USPS), and the secure provider may maintain an account on behalf of each recipient that will accrue shipping and purchasing costs.

Yet another way of viewing the inventive subject matter is a method of delivering a physical item to a recipient who is determined by the sender of the item. The sender may not rely upon access to the physical location of the recipient, but the item may nevertheless be delivered because the item is associated with an IAC which is associated with the recipient's deliverable address.

An additional aspect is a method of shipping an ordered item where an order is placed requesting delivery to an IAC. A deliverable shipping address may be derived from the IAC.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic of the creation of an indirect address code.

FIG. 2 is a schematic of the path of an item through the system.

FIG. 3 is a schematic of a transaction with a mail order vendor or online vendor.

FIG. 4 is a schematic of a change of address using an indirect address code.

### DETAILED DESCRIPTION

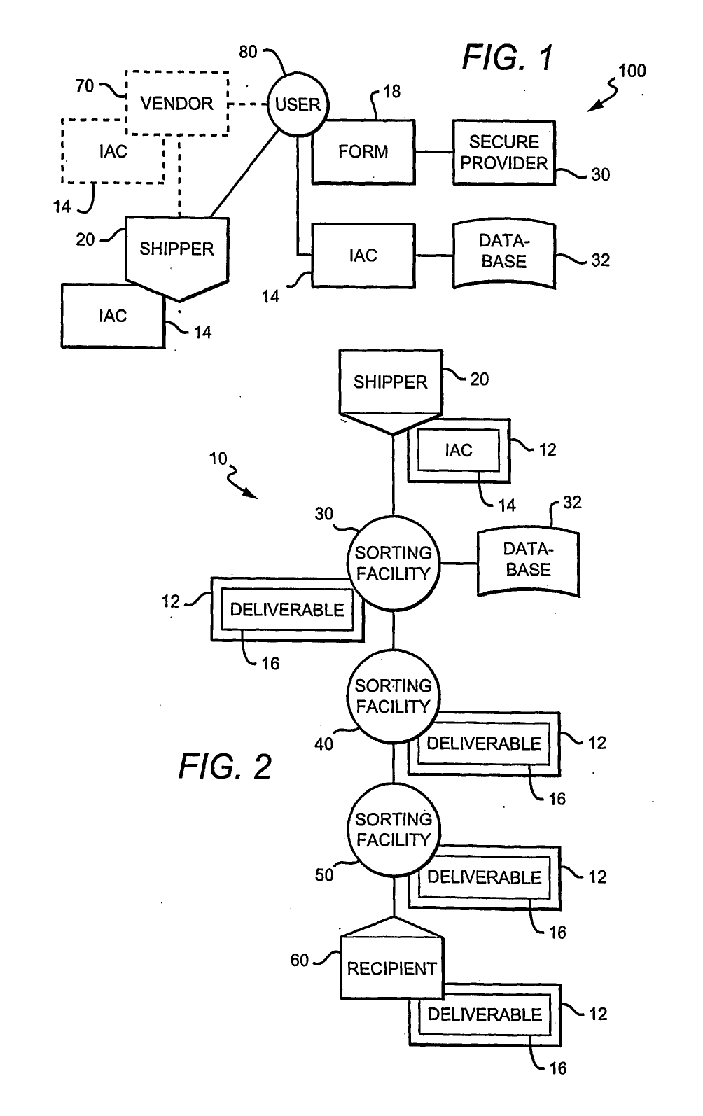

FIG. 1 depicts a process of creating an indirect address code (IAC). A user 80 fills out a Request for an IAC form 18, and submits the form 18 to a secure provider 30. The secure provider 30 enters information from the form 18 into a database 32, and creates an IAC 14 that is then sent to the user 80, who may provide it to a vendor 70 and/or a shipper 20.

As used herein, an “indirect address code” is defined as a unique set of characters that can be evaluated into a fully specified deliverable address only through the use of a reference table. The unique set of characters that comprise the IAC have no human discernable indication of the deliverable address. Specifically, there is no human discernable street number, street name, city, state or zip code. A “fully specified deliverable address” (throughout this document referred to simply as a “deliverable address”) is defined as sufficient information to enable a deliverer or other entity to transport an item, preferably to an intended geographical location associated with the full specified deliverable address. Hence “undeliverable” refers to insufficient information to enable the deliverer or other entity to transport the item.

A postal code, such as a ZIP+4+2 or other ZIP code, is not an IAC because it does not necessarily require a reference table to obtain a deliverable address. Similarly, a coded address such as “The White House” is not an IAC because it provides a human discernable indication of the deliverable address, and it is susceptible to evaluation without the reference table. A Post Office Box number is not an IAC because it can be associated with a particular post office without the use of a reference table. An electronic mail address is not an IAC because it is a deliverable address. An encrypted address is not an IAC because it is susceptible to evaluation without the reference table.

The user 80 may be any entity capable of being the recipient of a physical item including an individual person, a family, and a company. Often the user 80 is an individual who desires to make a purchase without revealing his name and address. In other instances, the user 80 may be a company involved in e-commerce that wants its business relationships to remain confidential or persistent across relocations. Another user may be a college student who changes addresses frequently, but does not want to have to notify his friends and family every time he moves.

The user 80 preferably fills out a “Request for an IAC” 18 or similar form, having at least one deliverable address. Although the form 18 may contain any number and variety of fields, a contemplated version has fields for name, deliverable address with corresponding date, alternative delivery address(es), special shipping instructions, demographic and psychographic information; a credit card number and/or bank account number, and authentication information.

The secure provider 30 is typically the entity that is responsible for assigning the IAC and maintaining the database. The secure provider 30 may be an authorized carrier, such as the United States Postal Service (USPS), United Parcel Service™, Federal Express™, and DHL Airborne Express™, or their agents. The secure provider may also be a wholly separate entity. Although there may be multiple secure providers 30, it is contemplated that the secure provider 30 can be a sorting facility or an office of the United State Postal Service (USPS) including a General Mail Facility, a Regional Mail Facility, and a Local Post Office. The secure provider 30 is preferably an entity that is trusted to maintain the information securely.

In a preferred embodiment, the secure provider 30 accepts the “Request for an IAC” form 18 (which may be a paper form, an electronic form or some other medium), enters information from the form 18 into a system having an IAC database 32, and generates an IAC 14. The secure provider 30 may then assign the IAC to the appropriate user 80.

As used herein, the term “allowing the recipient a capability of modifying the deliverable address” includes any way that an entity can accomplish changing the deliverable address including giving an entity a web site where the deliverable address may be changed. Regardless of how the deliverable address is changed, in a preferred embodiment the recipient should be authorized before allowing him to initiate a change to the deliverable address.

It is contemplated that only certain “privileged” entities are able to perform a database query (or have a query performed on their behalf). In that manner, a particular entity may have access to only a subset of the fields in the resulting record. For example, the authorized carrier may be allowed to view the deliverable address(es) and the delivery criteria, but may not be privileged to view authentication information or financial information. Other entities might only be privileged to view financial information. Still others might only be privileged with the knowledge that the IAC exists in the database (i.e. that it is a valid IAC).

The IAC Database

The preferred functions of the IAC database 32 are to store and provide data enabling the evaluation of an IAC into a deliverable address. The database is typically comprised of at least a reference file. It is contemplated that the IAC database 32 is controlled (and accessed) by the secure provider 30. In embodiments where there is an authorized carrier in addition to the secure provider, the authorized carrier is typically given read-only access to the IAC database. For the most part, the secure provider 30 is responsible for the integrity and security of the data, and the database is advantageously secure from hackers and other unauthorized entities.

The IAC database 32, may be any type that can provide a lookup based on the IAC. The database may be distributed among multiple storage devices and processors and may be mirrored any number of times. Preferably, the IAC database is distributed such that bottlenecks are minimized.

The envisioned database comprises at least one file, typically the reference file, having at least a field for the IAC, and at least another field for the related deliverable address. The IAC may be linked to derivative information such as fields that will enable the secure provider 30 to charge purchases and shipping costs to the user 80, and fields that will enable the secure provider to confirm the identity of someone requesting to modify the contents of a field on the database. The LAC may also be linked to at least one email address. In other aspects of the invention, the database may contain any number of files and fields including multiple addresses with associated dates, shipping instructions,

Online Purchase

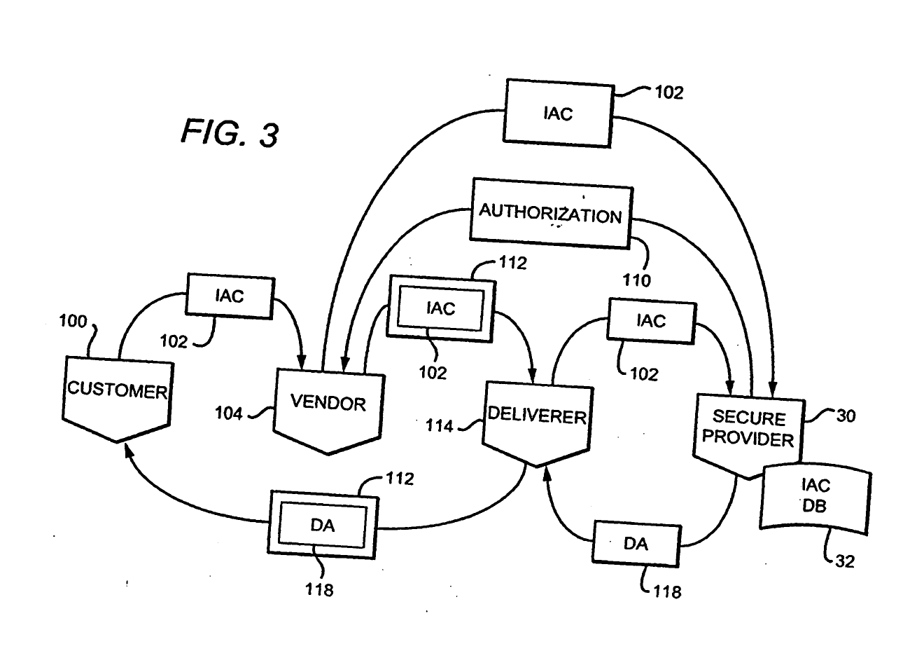

In FIG. 3, a customer 100 making an online purchase may choose not to provide his name, address, and credit card number to a vendor 104. Perhaps the vendor's credibility is unknown or the credit card number is susceptible to being stolen. Likewise, the customer's name and address might be susceptible to collection and distribution for the purpose of solicitation or profiling. In such a situation, the IAC 102 may be provided to the vendor 104 instead of a deliverable address. While the IAC 102 itself could in principle be used for solicitation or profiling, the preferred embodiment allows the user 100 to cancel the IAC 102. In another alternative, the IAC 102 expires automatically after some number of uses or a certain period of time.

By associating a credit card number and deliverable address with an IAC 102, the purchaser's name, address, and credit card number are not needed by the vendor 104. In the preferred embodiment, the vendor 104 supplies the IAC 102 to the secure provider 30 who uses the IAC 102 to obtain the customer's credit card number and charge the customer 100 for the amount of the purchase and delivery. The secure provider confirms the charge by returning an authorization 110 to the vendor 104. In an alternative embodiment, the vendor 104 provides the IAC 102 to a third party (not shown), such as a credit card company that uses the IAC 102 to obtain authorization information from the IAC database 32. The authorization information may be the information necessary to authorize the purchase and charge the customer 100. Because the credit card number is not passed from the purchaser to the vendor, the threat of misappropriation is greatly reduced.

As used herein, the term “associating” means connecting, either physically or logically. It is contemplated that an IAC may be associated with a physical item by any method that connects the IAC to the physical item including affixing a label, spraying an IAC, and affixing a bar code that evaluates into the IAC. The term “associating” is also used herein to refer to the connection between the deliverable address and the physical item.

Having obtained authorization for the purchase, the vendor 104 associates the IAC 102 to the purchased product 112 and supplies both to the deliverer 114. The deliverer 114 is authorized to use the IAC 102 to obtain a deliverable address 118 from the secure provider 30. The deliverer 114 then associates the deliverable address 118 to the product 112 and subsequently delivers the product 112 to the purchaser 100.

Many vendors sell or otherwise provide names and addresses of their customers without permission by the customers. The purchaser of the names and addresses often uses such information in conjunction with a list of property owners to target purchasers of certain items who live in certain areas. The purchaser may also combine customer information from various sources, using the customer's name and address to correlate the information. By using an IAC when making a purchase, the association of purchases with identity is not possible, and therefore this type of solicitation is minimized.

Providing an IAC to a vendor may reduce misdelivery of an item. First, with an IAC, there may be less opportunity to make a mistake in entry of the deliverable address. Second, with an IAC, there may be less probability that a package will be misdelivered because the purchaser has moved. If the purchaser moves or changes his ship-to address and doesn't notify a vendor with whom he has an outstanding order, the order will likely be shipped to his old address. In a situation where a purchaser has many orders outstanding, the process of notifying each vendor can be onerous. If the purchaser,uses an IAC when placing the orders, all he has to do is notify the secure provider that he has changed his shipping address, and the items will automatically be routed to the correct deliverable address. If the change is just temporary, the purchaser may want to provide a corresponding date along with the new shipping address.

The vendor of the item may also benefit from the use of an IAC. Preferably, the IAC will have fewer bytes than a full name and address. Consequently, entry of an order is likely to be faster, contention for system resources may be reduced, and storage requirements may be reduced. In addition, because the IAC may have a validity check, vendors could use the validity check to prune their customer databases of obsolete entries, thereby reducing the waste and expense of misdirected advertising. Since upwards of 15% of Americans change address each year and direct mail is not by default forwarded by the USPS change-of-address system, the savings could be quite significant.

A Permanent Address Code

An IAC may be retained for the life of the recipient. The concept of a permanent address code could eliminate the need to communicate one's new address to multiple parties each time a change of address occurs. Upon notifying the secure provider, all deliveries could be automatically routed to the new address. Although the concept of a permanent address is contemplated, the IAC for an entity may change, terminate or even be merged with another entity. In a related aspect, a family living at a single address may all share the same IAC. A single recipient may also have more than one IAC. For example, the recipient may have one IAC for personal use and another for a home-based business.

Change of Address

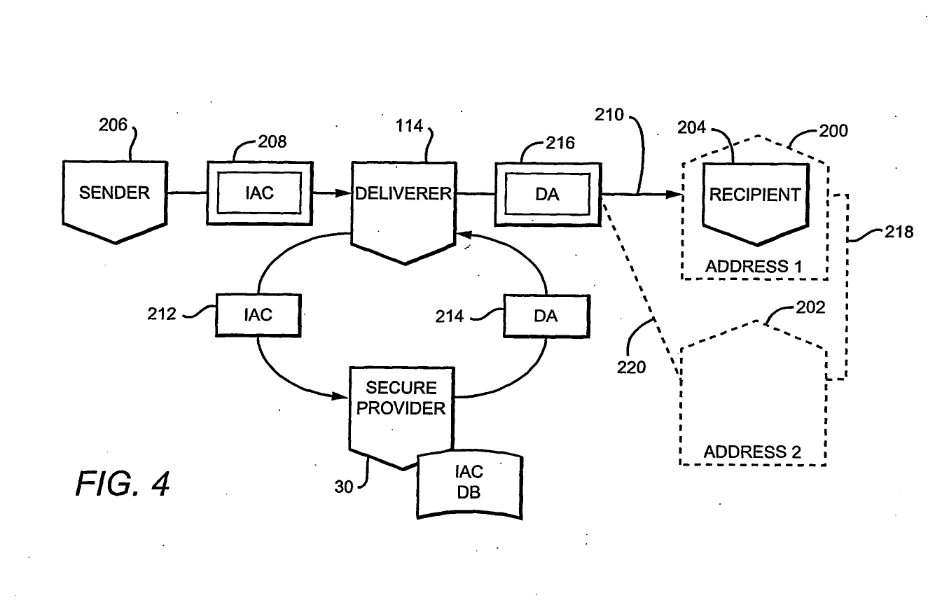

In FIG. 4 a recipient 204 may reduce the cost, inconvenience, and potential for error associated with a change of address by providing an IAC 208 instead of an address 200. A sender 206 can send mail or parcels using the IAC 208. The deliverer 114 provides the IAC 208 to the secure provider 30, who returns a deliverable address 214. The deliverable address 214 is added to the mail piece 216 and the mail piece 216 is travels along path 210 to the recipient 204. When the recipient 204 moves to a new residence 202 via path 218, a request is made that the secure provider 30 update the deliverable address 214 associated with the recipient's IAC 208. It is not necessary to notify friends, family, business contacts . . . of the move since they can continue to use the same IAC. When the deliverer 114 delivers a mail piece 216 having the IAC 208, to the secure provider 30, the secure provider 30 may automatically return the updated deliverable address 214. In a particular embodiment, the deliverer 114 associates the deliverable address 214 to the mail piece 216 and delivers the mail piece 216 to the new address 202 via path 220. The process exemplified in FIG. 4 significantly simplifies a change of address for both the recipient 204 and the sender 206.

Double Indirection

The capability for “double indirection” is also contemplated. Specifically, an IAC could evaluate to a second IAC, which is subsequently evaluated to a deliverable address. Double indirection may be desirable when a user wishes to combine the convenience and continuity of a permanent IAC with the privacy and anonymity of a temporary IAC.

Verification Methods

It is helpful for the IAC to have some level of resistance to error. The IAC may be made relatively more resistant to error by providing a method of verification that detects and corrects errors within the IAC. Such verification methods could reduce the frequency of errors, especially those associated with transcription. Two contemplated types of error are human error and machine error. In either case, built in verification methods may be used to eliminate many errors.

To help avoid machine error, one common method of verification is the inclusion of a checksum within the IAC. The cyclic redundancy check (CRC) returns a number that uniquely identifies the data Preferably, a first number is derived from a first cyclic redundancy check calculation. In accordance with this embodiment, when the IAC is evaluated, a second number is calculated and compared to the first number. If the two numbers match, or are “close enough” in terms of correctability, the IAC can be presumed valid.

The IAC may also have a system to reduce interpretation errors by humans or by OCR systems that process a scanned image of the IAC. One such system may limit the character set used by the IAC. For example, it is common for humans and OCR systems to mistake the letter “O” for the number “0” or vice versa. A preferred IAC excludes one or both of the letter “O” and the number “0”. Similarly, a preferred system excludes one or both of the letter “l” and the number “1”. Another interpretation is that “O” and “0” are treated as the same symbol.

In one embodiment, both the recipient's name and associated IAC are required to obtain a deliverable address. In this case, an error detection and correction procedure may operate on any combination of the name and IAC.

In FIG. 2, the path of an item 12 is followed from shipper 20 to recipient 60. Here, the shipper 20 may assign an IAC to an recipient 60. The assignment of the IAC may also be made by the authorized carrier, common carrier, or any other party authorized to make the assignment. In any event, the IAC is added to the item, the item is put into the stream of delivery, and eventually arrives at a sorting facility 30 local to the shipper 20. At the sorting facility 30, the IAC 14 is evaluated into a deliverable address 16. Evaluation may be at least partially automatic in that some portion of the step of evaluation is not manual. For instance, a machine scan may be done on the IAC, then the result of the scan may be used to access a record in a reference file. Evaluation preferably yields the deliverable address, which allows the item to be forwarded onto a regional sorting facility 40. Typically, the item will end up at another sorting facility 50, local to the recipient 60, where it will be picked up by a delivery person, and physically delivered (transported) to the recipient 60. In another embodiment, multiple carriers might be involved in delivering the item, one of which performs the evaluation of the IAC to a deliverable address (or requests that the secure provider perform the evaluation on their behalf). The evaluation might occur more than once in the delivery stream.

Adding the Deliverable Address to the Item

The deliverable address 16 is preferably associated to the physical item 12 after the item has been placed into the stream of delivery, and in associating the deliverable address 16, the IAC 14 may be obscured. Alternatively, it is contemplated that the IAC may be removable, or added to the item 12, such that the IAC is not obscured. Other proposed embodiments include affixing a label to the item, spraying or printing the deliverable address 16 directly onto the item 12, or adding a barcode.

Physical Delivery

As used herein, the “stream of delivery” begins once the item leaves the hands of an entity that has a function other than delivering the item. For example, a manufacturer, a vendor, and a distributor all have functions that do not concern delivery of the item. The stream of delivery continues until the item arrives at the geographic location associated with the deliverable address. Delivery of the item 12 is generally accomplished by the secure provider 30, authorized carrier(s), or other authorized deliverer(s). Preferably a delivery person will obtain an item 12 at a sorting facility 30 located near the shipper 20. The item 12 may be delivered to a regional sorting facility 40, then a local sorting facility 50 before being physically transported to the recipient 60.

Thus, specific embodiments and applications of a virtual post office box have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A method of delivering a physical item, comprising:
associating an indirect address code (IAC) to the physical item;
placing the physical item into a stream of delivery;
using a reference file to evaluate the IAC into a deliverable address wherein the step of using occurs after the step of placing;
associating the deliverable address with the physical item; and
physically transporting the item to a geographic location associated with the deliverable address.

2. The method of claim 1 wherein the physical item comprises a box containing a good ordered via electronic commerce.

3. The method of claim 1 wherein step of using a reference file is at least partially automatic.

4. The method of claim 3 wherein the step of using a reference file includes machine-scanning the IAC.

5. The method of claim 1 wherein the step of using a reference file further comprises the step of evaluating the IAC into a second IAC.

6. The method of claim 1 wherein the reference file comprises at least a special delivery instruction associated with the IAC.

7. The method of claim 1 wherein the reference file comprises at least an item of demographic information associated with the IAC.

8. The method of claim 1 wherein the reference file comprises an electronic mail address associated with the IAC.

9. The method of claim 1 wherein the reference file comprises at least one item of authentication information associated with the IAC.

10. The method of claim 1 wherein the step of associating the deliverable address comprises affixing a physical label to the physical item.

11. The method of claim 1 wherein the step of associating the deliverable address comprises logically relating the deliverable address to the physical item.

12. The method of claim 1 wherein the step of associating the deliverable address comprises labeling the physical item with a barcode.

13. The method of claim 1 wherein the deliverable address obscures the IAC.

14. The method of claim 1 wherein the IAC includes verification data.

15. The method of claim 14 wherein the verification data comprises a cyclic redundancy check.

16. The method of claim 14 wherein the verification data comprises an error correction code.

17. The method of claim 1 wherein the IAC is undeliverable without evaluation into the deliverable address.

18. A method of delivering a physical item from a sender to a recipient comprising:
the sender, without access to a deliverable address, associating an indirect address code (IAC) to the physical item;
using a reference file to evaluate the IAC into the deliverable address;
associating the deliverable address with the physical item; and
using the deliverable address to deliver the physical item to the recipient.

19. The method of claim 18 wherein the physical item comprises a box containing a good ordered via electronic commerce.

20. The method of claim 18 wherein step of using is at least partially automatic.

21. The method of claim 20 wherein the step of using includes machine-scanning the IAC.

22. The method of claim 18 wherein the step of using a reference file further comprises the step of evaluating the IAC into a second IAC.

23. The method of claim 18 wherein the reference file comprises at least a special delivery instruction.

24. The method of claim 18 wherein the reference file comprises at least one item of authentication information.

25. The method of claim 18 wherein the step of associating the deliverable address comprises affixing a physical label to the physical item.

26. The method of claim 18 wherein the deliverable address obscures the undeliverable address code.

27. The method of claim 18 wherein the IAC includes verification data.

28. The method of claim 18 wherein the sender does not have knowledge of the recipient's deliverable address.

29. A method of shipping an ordered item, comprising:
assigning an indirect address code (IAC) to a recipient;
associating a deliverable address with the IAC;
allowing the recipient a capability of modifying the deliverable address associated with the IAC;
accepting an order from the recipient requesting delivery of a physical item to the IAC;
placing the item bearing the IAC and not bearing the deliverable address in a human readable form into a stream of delivery; and
using a reference file to evaluate the IAC into a deliverable address.

30. The method of claim 29 wherein the step of assigning is performed under authority of the USPS.

31. The method of claim 30 wherein the step of assigning is performed by a common carrier.

32. The method of claim 29 wherein the step of assigning includes charging the recipient a periodic fee.

33. The method of claim 32 wherein the step of allowing includes charging the recipient a transaction fee.

34. The method of claim 29 wherein the recipient is charged a setup fee.

35. The method of claim 29 further comprising billing a purchasing cost against an account linked to the IAC.

36. The method of claim 29 wherein the step of accepting the order comprises the vendor receiving the order electronically.

37. The method of claim 29 wherein the IAC is associated with more than one order.

38. The method of claim 29 wherein the IAC is linked to authentication information.

39. The method of claim 38 wherein the authentication information is used to confirm the identity of the recipient before allowing the recipient to modify the deliverable address associated with the IAC.

40. The method of claim 38 wherein the authentication information is used to confirm the authorization to purchase the physical item.

41. The method of claim 29 wherein the IAC is linked to derivative information.

42. The method of claim 41 wherein the derivative information includes the cost of delivering an item to the deliverable address associated with an IAC.

43. The method of claim 41 wherein the derivative information includes the active status of an IAC.

44. The method of claim 29 wherein the IAC is linked to a plurality of deliverable addresses.

45. The method of claim 44 wherein the IAC evaluates to one of the plurality of deliverable addresses based on the date of delivery.

46. The method of claim 45 wherein the IAC evaluates to one of the plurality of deliverable addresses based on the time of day.

47. The method of claim 45 wherein the IAC evaluates to one of the plurality of deliverable addresses based on some characteristic of the item being delivered.

48. The method of claim 29 wherein the IAC is linked to at least one electronic mail address.

49. The method of claim 48 wherein the electronic mail address is used to inform the recipient of the step of shipping.

50. The method of claim 48 wherein the recipient may opt to receive additional information or solicitations by electronic mail.

51. The method of claim 29 wherein the step of allowing includes giving the recipient the capability to modify the deliverable address electronically.

52. The method of claim 29 wherein linked information comprising authentication information, derivative information, a plurality of deliverable addresses, and electronic mail information is linked to the IAC, and at least a subset of the linked information is made available to an authorized party.
